(19) United States
(12) Patent Application Publication
(10) Pub. No.: US 2013/0202289 A1
(43) Pub. Date: Aug. 8, 2013

(54) METHOD AND DEVICE FOR PROVIDING ON-BOARD FAILURE LOGGING FOR PLUGGABLE OPTICAL MODULES

(71) Applicants: Norman Tang, Los Altos, CA (US); Liang Ping Peng, Santa Clara, CA (US); David Lai, Mountain View, CA (US); Anthony Nguyen, San Jose, CA (US)

(72) Inventors: Norman Tang, Los Altos, CA (US); Liang Ping Peng, Santa Clara, CA (US); David Lai, Mountain View, CA (US); Anthony Nguyen, San Jose, CA (US)

(73) Assignee: CISCO TECHNOLOGY, INC., San Jose, CA (US)

(21) Appl. No.: 13/367,569

(22) Filed: Feb. 7, 2012

(51) Int. Cl. H04B 10/08

(52) U.S. Cl. 398/17

(57) ABSTRACT

A method of capturing a failure log for an optical module may be provided. The optical module may have an optical monitoring circuit and a buffer memory. The method may include measuring environment variables of the optical module using the optical monitoring circuit, and storing the measured environment variables in the buffer memory. In addition, the method may also include receiving time of day information. The measured environment variables may then be associated with the time of day information.

### BACKGROUND

Pluggable optical modules, and particularly the hardware therein, have become increasingly complex in recent years. In addition, pluggable optical modules (or host systems to which the modules are connected) installed at customer sites or in the field may fail for various reasons. Thus, a method for reconstructing the exact failure is needed in order to repair and/or improve the pluggable modules. However, due to the increasing complexity, reconstruction can be challenging. In particular, reconstruction may be difficult due to differences in module configuration and setup, module environment variables and failure conditions. Further, reconstruction may not be feasible because of the financial impact on the customer and the anticipated service interruption.

### SUMMARY

Disclosed herein are methods and apparatuses for providing on-board failure logging (OBFL) capability to pluggable optical modules. By providing OBFL capability, engineers may be able to more easily reconstruct the exact failure occurring on either the pluggable optical modules or the host systems. Specifically, in order to assist troubleshooting failures, environment variables of the optical modules, failure of events, optical module statuses, etc. may be captured and stored in memory of the optical module such that the root cause for the failure can be determined at a later point in time.

A method of capturing a failure log for an optical module for use with a host system may be provided according to one implementation of the invention. The optical module may include an optical monitoring circuit and a buffer memory. The method may include: measuring environment variables of the optical module using the optical monitoring circuit; capturing an optical module control and status signal and storing the measured environment variables and the optical module control and status signal in the buffer memory.

Optionally, the method may include receiving time of day information. The measured environment variables and the optical module control and status signal may then be associated with the time of day information.

In some implementations, the time of day information may be received from the host system.

In other implementations, the time of day information may be extracted from network data.

Alternatively or additionally, the method may include receiving time of day information, measuring environment variables of the optical module using the optical monitoring circuit, capturing an optical module control and status signal and storing the measured environment variables and the optical module control and status signal in the buffer memory every predetermined time period. For example, the predetermined time period may be 1 second.

In one implementation, the method may include storing the measured environment variables and the optical module control and status signal in the buffer memory using a round-robin algorithm.

In addition, the environment variables may include at least one of temperature, supply voltage, transmission optical power and reception optical power of the optical module.

An optical module for use with a host system may be provided according to another implementation of the invention including: an optical monitoring circuit configured to measure environment variables of the optical module; a buffer memory; and a computing device configured to receive the measured environment variables, capture an optical module control and status signal and store the measured environment variables and the optical module control and status signal in the buffer memory.

Optionally, the computing device may be configured to receive time of day information. The measured environment variables and the optical module control and status signal may then be associated with the time of day information.

In some implementations, the time of day information may be received from the host system.

In other implementations, the time of day information may be extracted from network data.

Alternatively or additionally, the computing device may be configured to receive time of day information, receive the measured environment variables of the optical module, capture an optical module control and status signal and store the measured environment variables and the optical module control and status signal in the buffer memory every predetermined time period.

The computing device may also be configured to store the measured environment variables and the optical module control and status signal in the buffer memory using a round-robin algorithm.

In addition, the buffer memory may be EEPROM. Alternatively or additionally, the buffer memory may have a capacity of 25.2 k bytes.

Further, the environment variables of the optical module may include at least one of temperature, supply voltage, transmission optical power and reception optical power of the optical module.

A non-transient computer-readable storage medium may be provided according to yet another implementation of the invention. The storage medium may have computer-executable instructions stored thereon that cause a computing device of an optical module for use with a host system to: receive measured environment variables of the optical module from an optical monitoring circuit; capture an optical module control and status signal and store the measured environment variables and the optical module control and status signal in a buffer memory.

In some implementations, the computer-executable instructions may cause the computing device to receive time of day information. The measured environment variables and the optical module control and status signal may then be associated with the time of day information.

Alternatively or additionally, the computer-executable instructions may cause the computing device to receive time of day information, receive measured environment variables of the optical module from the optical monitoring circuit, capture an optical module control and status signal and store the measured environment variables and the optical module control and status signal in the buffer memory every predetermined time period.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A and 1B are block diagrams illustrating pluggable optical modules without OBFL capability;

FIG. 2 is a block diagram illustrating a pluggable optical module having an existing computing device for providing OBFL capability according to an implementation of the invention;

FIG. 3 is a block diagram illustrating a pluggable optical module to which a computing device is added for providing OBFL capability according to an implementation of the invention; and

FIG. 4 illustrates an example flow diagram for providing OBFL capability to a pluggable optical module according to an implementation of the invention.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for providing OBFL capability to pluggable optical modules, it will become evident to those skilled in the art that the implementations are not limited thereto, but are applicable for providing OBFL capability to other devices.

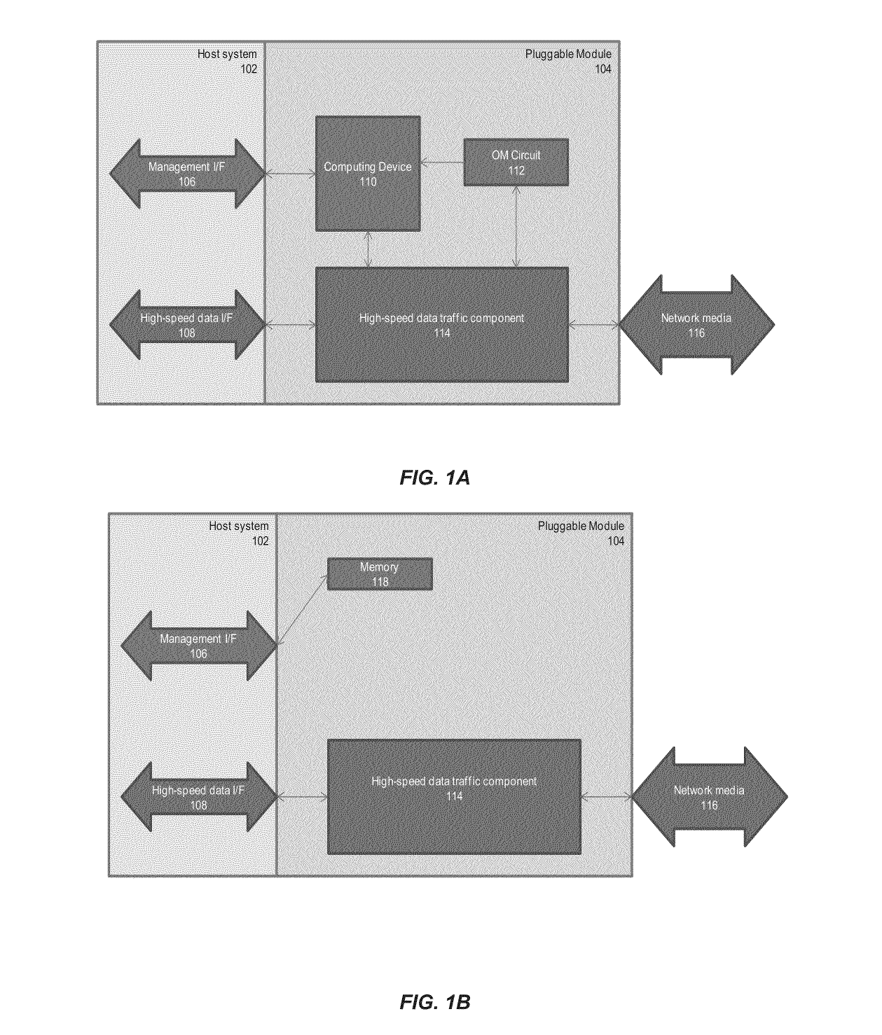

FIG. 1A shows a block diagram of a pluggable optical module without OBFL capability. The pluggable module 104, which may be used for converting electrical signals to optical signals (and vice versa), for example, may be connected to a host system 102. The pluggable module 104 may include a high-speed data traffic component 114 that provides the basic transmission network technology for transmitting bits (i.e., network data) over network media 116. The high-speed data traffic component 114 may be any implementation of the physical layer (PHY), a transmitter optical subassembly (TOSA), a receiver optical subassembly (ROSA), etc. The network media 116 may be any physical link used for connecting devices including optical fiber and copper wire such as optical fiber, coax cable, etc. The pluggable module 104 may be connected to the host system 102 via a high-speed data interface 108, such as an SFI, XFI, nAUI or XAUI interface, for example. The network data travels through the high-speed data interface 108. In addition, the pluggable module 104 may have a means for communicating with the host system 102 via a management interface 106.

The pluggable module 104 may also include a computing device 110. The computing device 110 may preferably include a processing unit and memory (i.e., volatile and/or non-volatile memory), for example. According to existing multisource agreements, pluggable modules should at least include a non-volatile EEPROM for storing information regarding the optical module. Thus, if the pluggable module 104 does not include the computing device, the pluggable module 104 should at least include memory for storing information regarding the pluggable module. This is discussed below with regard to FIG. 1B. The processing unit may be a standard programmable processor that performs arithmetic and logic operations necessary for operation of the computing device 110. The processing unit may be configured to execute program code encoded in tangible, computer-readable media. For example, the processing unit may execute program code stored in the system memory, which may be volatile or non-volatile memory. The system memory is only one example of tangible, computer-readable media. Other examples of tangible, computer-readable media include hard drives, flash memory, or any other machine-readable storage media, wherein when the program code is loaded into and executed by a machine, such as the computing device 110, the machine becomes an apparatus for practicing the disclosed subject matter.

In some implementations, the computing device 110 may be a microcontroller, i.e., an IC chip having a processing unit, system memory and programmable input/output interfaces. The system memory of the microcontroller may optionally be NVRAM. Additionally, the microcontroller may be programmed to control operations of the pluggable module 104.

The pluggable module 104 shown in FIG. 1A may also include an optical monitoring circuit 112. The optical monitoring circuit 112 should be capable of measuring environment variables such as module temperature, supply voltage, transmission optical power, reception optical power, or any other operating parameter of the pluggable module 104. For example, the optical monitoring circuit may include temperature sensor(s) for measuring module temperature and/or optical power detectors/meters for measuring optical power. Additionally, the optical monitoring circuit may include an A/D converter for converting analog measurements (i.e., temperatures, voltages, currents, etc.) into digital signals, which can then be processed by the computing device 110.

FIG. 1B also shows a block diagram of a pluggable optical module without OBFL capability. FIG. 1B includes many of the same features as FIG. 1A, and the similar features are not discussed in detail below. However, unlike the pluggable module 104 shown in FIG. 1A, the pluggable module 104 shown in FIG. 1B does not include a computing device or an optical monitoring circuit. Instead, the pluggable module 104 includes a memory (i.e., volatile and/or non-volatile memory) 118. For example, according to existing multisource agreements, pluggable modules should at least include a non-volatile EEPROM for storing information regarding the pluggable module. Thus, in some implementations, the pluggable module 104 may only include the memory 118 instead of the computing device and the optical monitoring circuit.

One skilled in the art would understand that the pluggable modules 104 shown in FIGS. 1A and 1B and described above are only examples and that different configurations of the pluggable modules may be utilized.

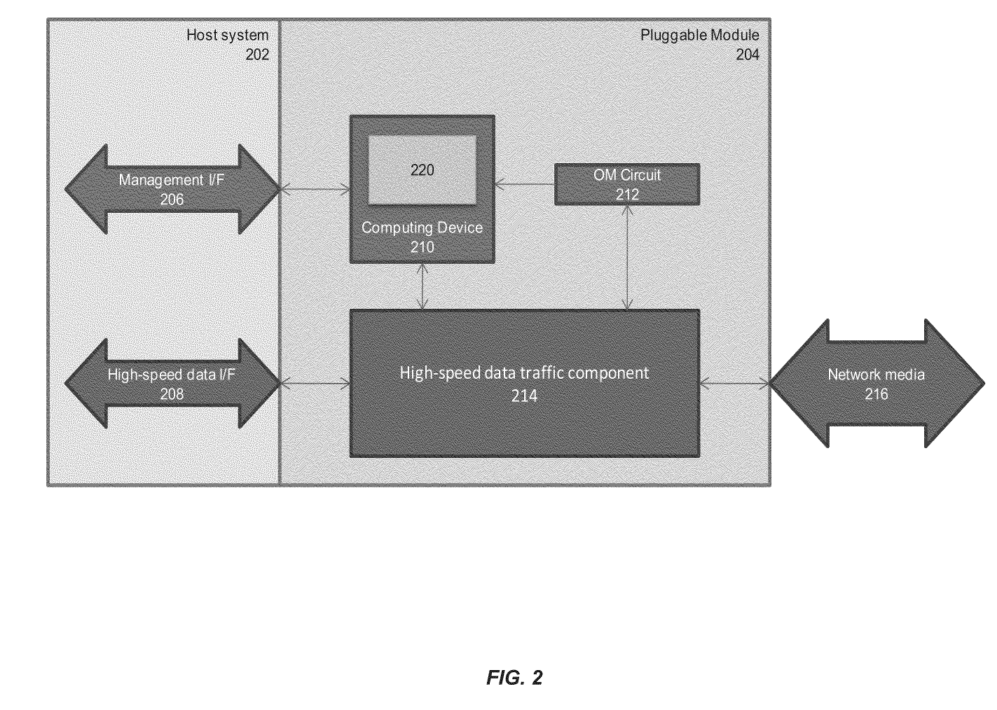

FIG. 2 illustrates a block diagram of a pluggable optical module having an existing computing device for providing OBFL capability according to an implementation of the invention. In some embodiments, the pluggable module 204 may include a high-speed data traffic component 214 for providing basic network transmission technology necessary for transmitting data over network media 216. The pluggable module 204 may also include a computing device 210 and an optical monitoring circuit 212. In addition, the pluggable module 204 may be connected to a host system 202 via a high-speed data interface 208 and a management interface 206. Because these features perform the same functions as discussed above, they are not discussed in detail with regard to FIG. 2. Further, the pluggable module 204 may include capacitor(s) that provide power to system components critical to storing the failure-related data before the pluggable module 204 completely loses power following module hot-plug or a system power outage.

In order to provide OBFL capability, the existing resources of the pluggable module 204 can be leveraged to store failure-related data to an internal memory (i.e., a non-volatile buffer memory, for example) for retrieval at a later time to reconstruct the exact failure. Thus, the existing memory of the computing device 210 may optionally be extended to retain the failure-related data. In addition, the pluggable module hardware (i.e., the optical monitoring circuit, for example) may be utilized to measure environment variables. In one implementation, the optical monitoring circuit 212 may measure module temperature, supply voltage, transmission optical power and reception optical power. A failure log module 220 executed by the computing device 210 may configure the measured environment variables for storage in the memory of the computing device 210. The failure log module 220 may be implemented using module firmware. However, one of ordinary skill in the art would understand that the failure log module 220 may also be implemented using hardware, firmware or software, or any combination thereof. In addition, the failure log module 220 may be configured to capture and store the pluggable module control and status signal, as well as the environment variables. The pluggable module control and status signal may contain information regarding module events such as system reset events, system alarm events and/or time of day (TOD) information. Each instance of stored data should preferably be associated with the TOD information (i.e., a time stamp) so that the sequence of failure events can be determined. However, the time stamp may optionally be stored only at the beginning of the round-robin in order to reduce the size of the memory required for storing the failure-related data. In some implementations, 7 bytes may be required to store the captured pluggable module environment variables and the control and status signal, for example. In particular, 1 byte may be required for each of the module temperature and supply voltage, 2 bytes may be required for each of the transmission and reception optical powers and 1 byte may be required for the control and status signal. Additionally, 5 bytes may be required for the time stamp included with each instance of failure-related data. For example, the 5 byte time stamp is calculated based on a decimal of 2-digit of year+2-digit of month+2-digit of day+2-digit of 24-h hour+2-digit of minutes+2-digit of seconds. Thus, the worst case is decimal “991231235959,” which equals hex 0xE6_C9_FC_{—}57_{—}77.

The size of the memory required to store the failure-related data may be determined based on the capture frequency and the desired sample period. In one implementation, in order to provide sufficient information to reconstruct the exact failure, the capture frequency may be every 1 second and the desired sample period may be 1 hour. Accordingly, the depth of the array required for storing the failure-related data is 3.6 k (i.e., 3,600 samples per hour). However, the capture frequency and the desired sample are not limited to the above example and may be set to any value by the host. The size of the required memory will increase by increasing the capture frequency and/or the desired sample period. For example, when the failure log module 220 is configured to capture and store the pluggable module environment variables and control and status signal every 1 second and the desired sample period is 1 hour, the memory must be capable of storing 3,600 samples. Thus, the maximum size of the memory required may be (7 byte failure-related data+5 byte time stamp)*3,600=43.2 k bytes. In addition, in order to minimize the size of the memory, the failure log module 220 may be configured to perform a round-robin storage algorithm. In other words, the memory becomes a circular buffer and when the buffer is full, a subsequent write is performed by overwriting the oldest data. Optionally, in order to further reduce the size of the memory, the 5 byte time stamp may only be stored at the beginning of the round-robin in other implementations. Because the capture frequency is known, the time associated with each instance of failure-related data can be derived based on the 5 byte time stamp stored at the beginning of the round-robin and the capture frequency. In this case, the minimum size of the memory required may be (7 byte failure-related data)*3,600+5 byte time stamp=25,195 bytes (i.e., 25.2 k bytes).

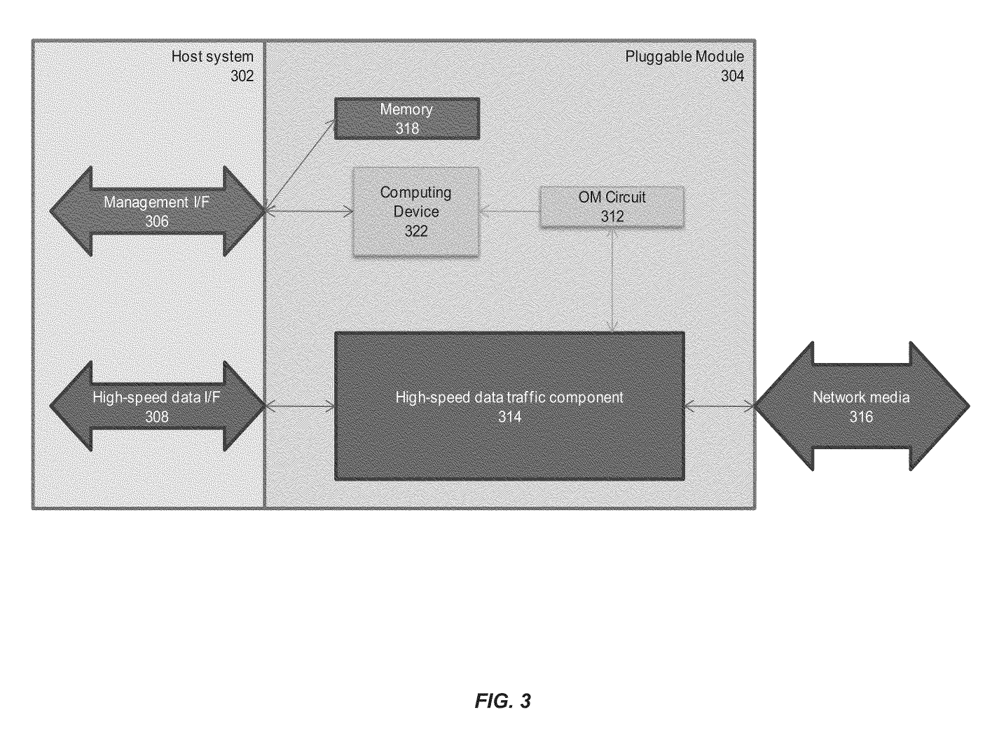

FIG. 3 illustrates a block diagram of a pluggable optical module to which a computing device is added for providing OBFL capability according to an implementation of the invention. In some embodiments, the pluggable module 304 may include a high-speed data traffic component 314 for providing basic network transmission technology necessary for transmitting data over network media 316. The pluggable module 304 may be connected to a host system 302 via a high-speed data interface 308 and a management interface 306. Because these features perform the same functions as discussed above, they are not discussed in detail with regard to FIG. 3. Further, the pluggable module 304 may include capacitor(s) that provide power to system components critical to storing the failure-related data before the pluggable module 304 completely loses power following module hot-plug or a system power outage.

As discussed above, the pluggable module 304 shown in FIG. 3 does not include a computing device or an optical monitoring circuit, and instead may only include a memory 318 for storing the optical module information. In order to provide OBFL capability, a computing device 322 and an optical monitoring circuit 312 may be added to the pluggable module 304. In some embodiments, the computing device 322 may contain a processing unit and a memory (i.e., volatile and/or non-volatile memory). In other embodiments, the computing device 322 may be a microcontroller such as a Renesas 78K Series @ 25-pin plastic FLGA (3×3) from RENESAS ELECTRONICS AMERICA INC., Santa Clara, Calif., for example. The computing device should be capable of executing a failure log module to capture and store the pluggable module control and status signal, as well as the environment variables, as discussed above with regard to FIG. 2.

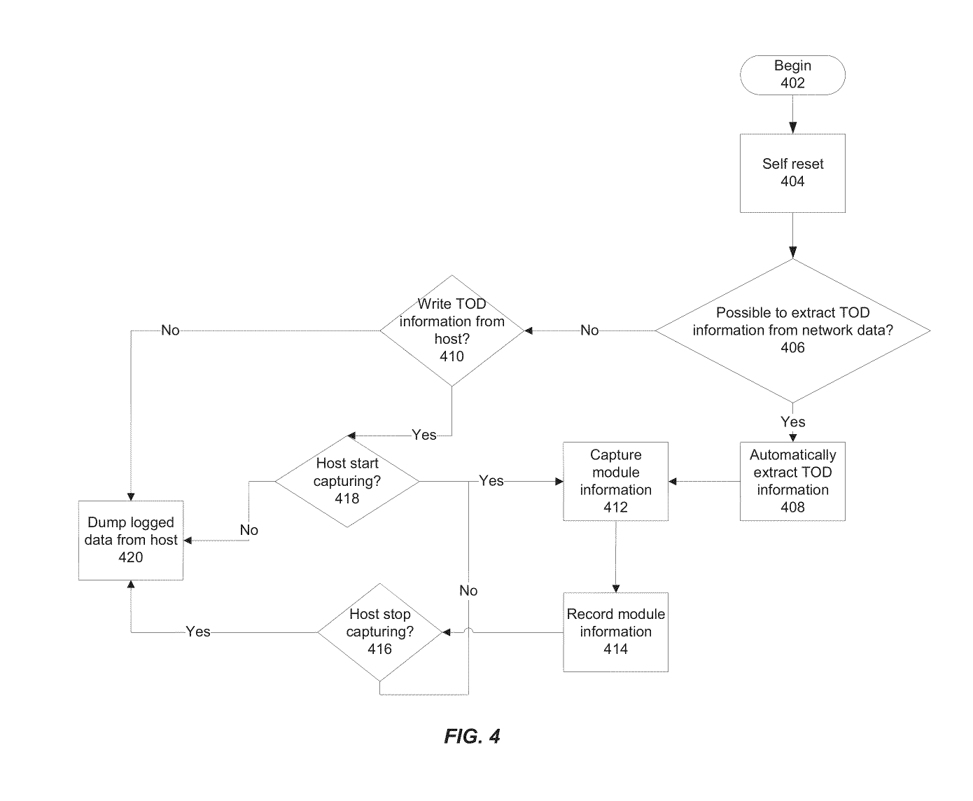

FIG. 4 illustrates an example flow diagram for providing OBFL capability to a pluggable optical module according to an implementation of the invention. The process for providing OBFL capability begins at 402. Then, at 404, the self reset, which may be independent from a module reset, may occur. As discussed above, information regarding the self reset may be included in the pluggable module control and status signal. Next, at 406 and 410, the TOD information is obtained. The TOD information should preferably be obtained and stored along with the measured environment variables such that each and every instance is time stamped so that the sequence of failure events can be determined accurately. At 406, the computing device determines whether it is possible to extract the TOD information from network data. For example, when the pluggable module supports Precision Time Protocol (PTP) defined in the IEEE 1588 standard, it is possible to automatically extract the TOD information each time the pluggable module environment variables and the control and status signal are captured at 408. However, when the pluggable module does not support PTP, the TOD information may be written from the host system at 410. The TOD information may be written over the management interface discussed above with reference to FIGS. 1-3, for example. After receiving the initial TOD information from the host system, the pluggable module may then generate the TOD information using the computing device. However, when the TOD information is generated using the computing device, the TOD information may not be accurate due to frequency variation of the silicon clock source of the computing device, and the TOD information may preferably be updated from the host system periodically such as every 30 minutes or 1 hour, for example.

After obtaining the TOD information, the pluggable module environment variables and the control and status signal may be captured at 412, and then the module information may be stored in memory at 414. As discussed above, the pluggable module environment variables and the control and status signal may be continuously captured and stored after determining that the host system should start capturing at 418 using a round-robin storage algorithm until determining that the host system should stop capturing at 416. The process for providing OBFL capability ends at 420 when the logged data is dumped from the host system.

It should be understood that the various techniques described herein may be implemented in connection with hardware, firmware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

By providing OBFL capability to pluggable optical modules, engineers may be able to more efficiently troubleshoot failures because the module environment variables, failure events and module statuses may be captured and stored by the pluggable module. In addition to facilitating reconstruction of the exact failure, providing OBFL capability to pluggable modules may reduce the cost of troubleshooting to the customer and minimize service interruptions with only an incremental cost increase in producing the pluggable module.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of capturing a failure log for an optical module for use with a host system, the optical module having an optical monitoring circuit and a buffer memory, the method comprising:
measuring environment variables of the optical module using the optical monitoring circuit;
capturing an optical module control and status signal; and
storing the measured environment variables and the optical module control and status signal in the buffer memory.

2. The method of claim 1, further comprising receiving time of day information, wherein the measured environment variables and the optical module control and status signal are associated with the time of day information.

3. The method of claim 2, wherein receiving time of day information comprises receiving the time of day information from the host system.

4. The method of claim 2, wherein receiving time of day information comprises extracting the time of day information from network data.

5. The method of claim 2, further comprising receiving time of day information, measuring environment variables of the optical module using the optical monitoring circuit; capturing an optical module control and status signal and storing the measured environment variables and the optical module control and status signal in the buffer memory every predetermined time period.

6. The method of claim 5, wherein the predetermined time period is 1 second.

7. The method of claim 6, wherein storing the measured environment variables and the optical module control and status signal in the buffer memory comprises using a round-robin algorithm.

8. The method of claim 1, wherein the environment variables of the optical module comprise at least one of temperature, supply voltage, transmission optical power and reception optical power of the optical module.

9. An optical module for use with a host system, comprising:
an optical monitoring circuit configured to measure environment variables of the optical module;
a buffer memory; and
a computing device configured to receive the measured environment variables, capture an optical module control and status signal and store the measured environment variables and the optical module control and status signal in the buffer memory.

10. The optical module of claim 9, wherein the computing device is further configured to receive time of day information, wherein the measured environment variables and the optical module control and status signal are associated with the time of day information.

11. The optical module of claim 10, wherein the time of day information is received from the host system.

12. The optical module of claim 10, wherein the time of day information is extracted from network data.

13. The optical module of claim 10, wherein the computing device is further configured to receive time of day information, receive the measured environment variables, capture an optical module control and status signal and store the measured environment variables and the optical module control and status signal in the buffer memory every predetermined time period.

14. The optical module of claim 13, wherein the computing device is further configured to store the measured environment variables and the optical module control and status signal in the buffer memory using a round-robin algorithm.

15. The optical module of claim 9, wherein the buffer memory is EEPROM.

16. The optical module of claim 15, wherein the buffer memory has a capacity of 25.2 k bytes.

17. The optical module of claim 9, wherein the environment variables of the optical module comprise at least one of temperature, supply voltage, transmission optical power and reception optical power of the optical module.

18. A non-transient computer-readable storage medium having computer-executable instructions stored thereon that, when executed by a computing device of an optical module for use with a host system, the optical module including an optical monitoring circuit and a buffer memory, cause the computing device to:
receive measured environment variables of the optical module from the optical monitoring circuit;
capture an optical module control and status signal; and
store the measured environment variables and the optical module control and status signal in the buffer memory.

19. The non-transient computer-readable storage medium of claim 18, having further computer-executable instructions stored thereon that, when executed by the computing device of the optical module, cause the computing device to receive time of day information, wherein the measured environment variables and the optical module control and status signal are associated with the time of day information.

20. The non-transient computer-readable storage medium of claim 18, having further computer-executable instructions stored thereon that, when executed by the computing device of the optical module, cause the computing device to receive time of day information, receive measured environment variables of the optical module from the optical monitoring circuit, capture an optical module control and status signal and store the measured environment variables and the optical module control and status signal every predetermined time period.
